(19) United States
(12) Patent Application Publication
(10) Pub. No.: US 2026/0237324 A1
(43) Pub. Date: Aug. 13, 2026

(54) SURGICAL TRAINING APPARATUS

(71) Applicant: IMRA IP PTY LTD, North Melbourne,Victoria (AU)

(72) Inventor: Shaun PATTEN, Chewton, Victoria (AU)

(21) Appl. No.: 19/156,482

(22) PCT Filed: Feb. 28, 2024
(86) PCT No.: PCT/AU2024/050160

§ 371 Date: Aug. 14, 2025

(30) Foreign Application Priority Data
Feb. 28, 2023 (AU) 2023900529

(51) Int. Cl. G09B 23/28

(52) U.S. Cl. CPC G09B 23/285

(57) ABSTRACT

A surgical training apparatus comprising a housing and a cassette: the housing comprising a synthetic layer to simulate skin; the cassette for holding one or more organ models in anatomical relationships with one another; the cassette engageable with the housing so as to be substantially surrounded by it and thereby define a body cavity with it; the cassette comprising synthetic bony anatomical features as landmarks.

### BACKGROUND OF THE INVENTION

In order to obtain realistic surgical experience trainee surgeons have in the past used human cadavers or live animals. Cadavers do not provide adequate fidelity as the tissue although real is chemically preserved and surgical training on live animals comes with serious ethical issues. Both of these past approaches were expensive and neither of them provided the ability to simulate various surgical conditions in need of repair. Furthermore, if a robotic surgical system is used on a cadaver or an animal it can not thereafter be used for surgery on humans. Such robotic surgical systems are too expensive to confine only to such training use.

Alternative, synthetic surgical training models have previously been developed. To date they have included silicone or hard resin-based models that do not have the ability to simulate human tissue to provide an accurate surgical training experience.

These models are typically used for training laparoscopic and robotic surgery using hard plastic ‘dome-trainers’ with precast holes for inserting surgical instruments for example as disclosed in recently filed United States Patent Application numbers US20230386366 and US20230343243.

There is an ongoing need for surgical training models that provide anatomically, pathologically and procedurally accurate simulations for a range of surgical techniques and procedures. Furthermore, there is a need for such training systems to be readily re-usable.

The reference to any prior art in this specification is not, and should not be taken as, an acknowledgement or any form of suggestion that the prior art forms part of the common general knowledge.

### SUMMARY OF THE INVENTION

According to a one aspect of the invention, there is provided a surgical training apparatus comprising a housing to substantially define a human or animal body cavity, and at least one organ model wherein the housing comprises an external surface through which surgical access can be made to the organ model. Surgical access means access to the body cavity or organs in a way that would be done in a real life surgical procedure. This may mean that it comprises an incision, or by insertion of one or more trocars or endoscopic devices (any surgical instrument used for an endoscopic procedure). For those embodiments which comprise use of one or more endoscopic devices, it may comprise maintaining an airtight seal of the external surface covering around the one or more endoscopic devices.

Some embodiments comprise a cassette for reversible engagement with the housing wherein the organ model is reversibly engageable with a support within the cassette and the cassette is adapted to be inserted within the housing to create the body cavity for surgical access to the organ model through the housing. In some embodiments, the cassette is engageable with the housing so as to create an airtight seal within the body cavity. The airtight seal may be created in any suitable manner. The housing may comprise a seal for airtight engagement with the cassette. The cassette may comprise a seal for airtight engagement with the housing.

In some preferred embodiments, the external surface of the housing is shaped to simulate a portion of human or animal anatomy. This enables the surgical trainee to practice using anatomical landmarks in order to identify the appropriate site for surgical access and for other parts of the procedure to be practiced.

In some preferred embodiments, the cassette is slidingly engageable with the housing. This enables the organ models to be easily arranged in anatomical positions within the cassette before it is slid into the housing. In some embodiments, this is further facilitated if the cassette is substantially drawer-shaped for slidable engagement into the housing.

Various other anatomical features may be part of the training apparatus to further facilitate the simulated environment. Some embodiments comprise an aperture located so as to simulate the location of an anatomical orifice. In some embodiments, the aperture may be utilised as part of one or more surgical procedures. Some embodiments, comprise a structure placed so as to anatomically simulate an underlying bone. Such structures can assist to provide anatomical landmarks for the trainee to utilise as well as assist to maintain other components such as organ models in correct anatomical relationships. In some embodiments, such a structure at least partially provides a structure for the shape of the external surface to simulate a portion of human or animal anatomy.

Additional features can be added to various embodiments to further improve the surgical simulation. For example, some embodiments comprise an electrical pathway to enable an electro cautery device to be used during training. Some embodiments comprise a fluid pathway to enable a simulated blood to be used during training.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1C is an elevated end perspective view of an example mould for a housing cover for a female surgical training apparatus according to the invention.

FIG. 1D is an elevated side perspective view of an example mould for a housing cover for a male surgical training apparatus according to the invention.

FIG. 2A is an elevated side view of the housing of the adult female surgical training apparatus of FIG. 1.

FIG. 2B is an elevated side view of an example housing for an adult male surgical training apparatus.

FIG. 2C is an elevated side view of an example housing for a further adult male surgical training apparatus.

FIG. 2D is an elevated side view of an example housing for a still further adult male surgical training apparatus.

FIG. 3 is an elevated end view of the housing of the adult female surgical training apparatus of FIG. 1.

FIG. 4 is an elevated side view of the cassette from the adult female surgical training apparatus of FIG. 1 with pelvic and ribcage models added.

FIG. 5 is an elevated side view of an example cassette from a surgical training apparatus according to the invention.

FIG. 6 is an elevated side view of the cassette of FIG. 5 with a pelvic model inserted.

FIG. 7 is an elevated side view of the cassette of FIG. 6 with a pelvic fat base model inserted.

FIG. 8 is an elevated side view of the cassette of FIG. 7 with a uterine model inserted.

FIG. 9 is a close-up elevated side view of the inferior end of the cassette of FIG. 8 to show more detail of the organ models.

FIG. 10 is a side diagrammatic representation of an example cassette according to the invention.

FIG. 11 is an elevated side view of the cassette of FIG. 6 with additional organ models inserted.

FIG. 12 is an elevated perspective view of an example paediatric surgical training apparatus according to the invention with the cassette open.

FIG. 13 is another elevated perspective view of a paediatric surgical training apparatus which is similar to that of FIG. 12.

FIG. 14 is an elevated perspective view of the paediatric surgical training apparatus of FIG. 12 with the cassette closed.

FIG. 15 is an elevated perspective view of an example paediatric surgical training apparatus of FIG. 13 with the cassette removed.

FIG. 16 is an elevated perspective view of the paediatric surgical training apparatus of FIG. 13 with the cassette partially open.

FIG. 17 is an elevated perspective view of the paediatric surgical training apparatus of FIG. 13 with abdominal organs removed.

FIG. 18 is an elevated perspective view of the surgical training apparatus of FIG. 17 with organs assembled separately and spare stomachs.

FIG. 19 is an elevated perspective view of a cassette according to the invention with pelvis and ribs.

FIG. 20 is an elevated perspective view of the cassette of FIG. 20 with vertebrae and inguinal hernia model inserted.

FIG. 21 is an elevated perspective view of the cassette of FIG. 21 from a different angle.

FIG. 22 is an elevated perspective view of assembled pelvis, vertebrae and inguinal hernia models according to the invention.

FIG. 23 is a photographic image of a surgical training apparatus of the invention in use.

FIG. 24A shows an example external door structure for a cassette according to the invention.

FIG. 24B shows the internal door structure from the cassette door of FIG. 24a.

### DETAILED DESCRIPTION OF EXEMPLARY EMBODIMENTS

It is convenient to describe the invention herein in relation to particularly preferred embodiments. However, the invention is applicable to a wide range of embodiments and it is to be appreciated that other constructions and arrangements are also considered as falling within the scope of the invention. Various modifications, alterations, variations and or additions to the construction and arrangements described herein are also considered as falling within the ambit and scope of the present invention.

In some embodiments, the invention provides a life size torso capable of insufflation into which hydrogel synthetic tissue organ models can be inserted. The hydrogel models are inserted into a custom cassette which can have background anatomy embedded into it. The cassette can have ports for electrical current access/connection and tubular access inserts for allowing simulated blood flow. The cassette may be air sealed for example with a mechanical locking device. This allows surgeons to train for surgical procedures in a situation that will not harm animals, use cadavers or involve training on a patient, and does not consign the robotic hardware for use only in training.

A large variety of training apparatus versions can be manufactured according to the invention. For example, paediatric models, such as for neonatal hernia repair, adult female models (lower torso) with and without a vaginal and/or anal orifice, for gynaecological surgeons to practice a total hysterectomy and other procedures and male anatomy (for example, a lower torso) with an anal orifice and penile replica for partial nephrectomy, prostatectomy, inguinal hernial, cholecystectomy and other procedures.

The apparatus of the invention creates a simulated environment which can utilise multiple hydrogel organs and allows surgical experience on different stages in the surgical procedures, representing varying gradients of difficulty, aimed at gradated surgical ability.

The training apparatus of the invention typically comprises three main structures; the internal cassette, the inner skeletal frame structure to provide structural integrity for a cover and organ models and the outer housing with a cover such as a skin layer.

The cassette may comprise an air-sealable door with another air sealed orifice at the other extremity. In some embodiments, air seals can be custom built using a silicone seal around the door. A preferred method is using a silicon gasket. The clips used to seal the door can be mechanical clamps to maintain internal pressure during gas insufflation. A sealed port for electrical current and perfusion may be embedded in the door.

The cassette may for example comprise three sections: the pelvis, the abdomen and the chest. Each section may have procedural models inserted into it. The pelvic section can be attached to the front of the cassette using an air sealed ring and for example, may be used to both lock the pelvis and cassette together as well as to attach the uterus (for example) and air seal the cavity. Around the pelvic structure a hydrogel pelvic fat pad can be inserted which provides further anatomic realism and allows current to connect with the hydrogel tissue. Other sections may have other anatomical organ structures which can for example be made of silicon (not hydrogel) to provide surgical landmarks and realism.

The invention also comprises an inner skeletal frame structure insert which contains sections of the pelvis that hold the stand and organs in place. This is also used for holding procedural models in the correct anatomical position.

According to one aspect of the invention, there is provided a surgical training apparatus comprising a housing and a cassette: the housing comprising a synthetic layer to simulate skin; the cassette for holding one or more organ models in anatomical relationships with one another; the cassette engageable with the housing so as to be substantially surrounded by it and thereby define a body cavity with it; the cassette comprising synthetic bony anatomical features as landmarks.

The cassette can comprise a drawer being slidably engageable with the housing. The cassette can be for holding one or more organ models in anatomical relationships with one another and with the external surface of the housing. The housing can be substantially covered on an operable surface by a cover which comprises a synthetic layer to simulate skin. The synthetic bony anatomical features can provide structural integrity for the cover and for anatomical placement and support of said organ models. The housing can be shaped externally to mimic a life sized torso. The cassette can comprise synthetic bony anatomical features as landmarks. The housing can comprise a side wall and a closed end and the closed end of the housing comprising a cassette-engaging end defining an aperture to receive the cassette. The synthetic skin is preferably sufficiently pliable so as to form a seal around a laparoscopic instrument passing therethrough. The engagement between the housing and the cassette preferably provides an airtight seal within the body cavity by means of a mechanical locking device.

In some embodiments the synthetic skin is heat repairable, sufficiently resilient to enable suturing and sufficiently distensible so as to enable life-like expansion when pressure is applied from within the body cavity through insufflation while maintaining said seal; the body cavity comprises a hydrogel synthetic pelvic fat pad placed on the pelvic model.

In some embodiments the synthetic bony anatomical features comprise one or more of a pelvic model, a rib model and a vertebral model; the hydrogel synthetic pelvic fat pad placed on the pelvic model is adhered to a diathermy pad, the pelvic fat pad to increase anatomical realism and provide a pathway for electrical current to connect with hydrogel tissue during electrocautery.

In some embodiments, the cassette comprises a drawer with an internal end, a support to hold an organ model, and an external end, the external end comprising a handle; the engagement between the housing and the cassette further comprising a seal on the housing and/or a seal on the cassette.

In some embodiments, the body cavity comprises one or more further organ models selected from: a thoracic organ, a lung, a heart, a thymus, an abdominal organ, a stomach, small intestines, large intestines, a colon, a gall bladder, a rectum, a liver, a pancreas, a spleen, a kidney, an adrenal gland, a bladder, a female reproductive tract, a male reproductive tract, a lymph node, a peritoneal tissue, omentum, mesentery.

In some embodiments, the engagement between the housing and the cassette further comprises a seal on the housing and/or a seal on the cassette, each seal optionally comprising a silicon gasket and each seal optionally housed in a channel around the perimeter of the respective engaging parts of the housing and cassette; the door of the cassette comprises an airtight sealed port for passage of an electrical cable to provide current access for cautery and an airtight sealed port for passage of one or more tubes to provide simulated blood flow access;

In some embodiments, the housing further comprises a tray and a side wall; the housing is shaped externally to mimic a life sized torso and substantially covered on an operable surface by a cover which comprises one or more synthetic layers to simulate a body wall, the synthetic layers comprising synthetic skin and optionally one or more of muscle, connective tissue and fat with each layer adhered to another layer; the cover comprises one more of an elastomer, a thermoplastic elastomer, a silicone, a room temperature vulcanizing silicone, a platinum cured room temperature vulcanization silicone; a saturated fatty acid; a pigment a foam, a cellular or solid polyethylene foam, a solid ethylene vinyl acetate (EVA) foam, a foam comprising air bubbles to provide cellular or tissue texture, a reduced polynomial hyperelastic material, a urethane polymer, a silicone fluid, a deadening agent to soften a silicone component, a platinum cured silicone additive, a silicone oil, an alcohol; a commercial synthetic skin product; the synthetic skin is sufficiently pliable so as to form a seal around a laparoscopic instrument passing therethrough such as a trocar; the engagement between the housing and the cassette provides an airtight seal within the body cavity by means of a mechanical locking device comprising one or more of a clasp, a clip, a clamp, a rotating airlock, the cassette comprises synthetic bony anatomical features as landmarks, the synthetic bony anatomical features to provide structural integrity for the cover and for anatomical placement and support of said organ models; the pelvic model comprises an engagement means with a slot to provide releasable engagement with a pillar of the inner wall of the organ model support, the pelvic model comprising a cap to fasten a synthetic peritoneal tissue in place.

In some embodiments, the closed end of the housing defines an aperture for passage of a portion of an organ model to simulate an anatomical orifice; internal end of the drawer defines an aperture for passage of an organ model to simulate an anatomical orifice; and the aperture defined by the closed end of the housing and the aperture defined by the internal end of the cassette arranged so as to form a continuous aperture for passage of an organ model to simulate an anatomical orifice; and the surgical training apparatus housing and cassette together define an aperture shaped to receive an aperture-bearing organ model to simulate an anatomical orifice, the organ model further comprising simulated internal anatomy associated with the orifice optionally comprising an organ lumen, the orifice selected from an anal orifice, a vaginal orifice, a penile orifice; and the aperture-bearing organ model, the housing and the cassette together form an airtight seal around the simulated orifice so as to enable insufflation of the body cavity while preserving the orifice and associated internal anatomical features which optionally comprising an organ lumen.

In some embodiments, the airtight seal around the simulated orifice comprises a flange on the aperture-bearing organ model wherein the flange is within the body cavity and on the inside of the aperture defined by the inner wall of the cassette and the airtight seal further comprising one or more annuli on an insert designed for air-tight fitting engagement with the organ model from outside the body cavity and outside the aperture; the insert comprises an annulus for tight fitting engagement with an external organ model such as a synthetic skin model to simulate an external orifice which is optionally an anus, a vulval opening or a penis wherein the external orifice is continuous with the orifice of the aperture bearing organ model within the body cavity.

In some embodiments, the cassette comprises a length of approximately 450 to 600 mm, preferably 500 to 550 mm, more preferably 520 to 530 mm, more preferably about 526 mm, and a height of 200 to 400 mm, preferably 250 mm to 350 mm, more preferably 280 to 300 mm, more preferably about 291 mm; the cassette engaging end of the housing comprises a first layer to adhere to a cover, a second layer to define an aperture for entry of the cassette and a third layer comprising a seal to engage in an airtight manner with an external end of the cassette.

In one aspect of the invention, there is provided a surgical training apparatus comprising a housing and a cassette:
the housing comprising a tray, side walls, and a closed end;
   the closed end of the housing defining an aperture for passage of a portion of an organ model to simulate an anatomical orifice and the close end of the housing comprising a cassette-engaging end defining an aperture to receive the cassette;
   the housing shaped externally to mimic a life sized torso and substantially covered on an operable surface by a cover which comprises one or more synthetic layers to simulate a body wall, the synthetic layers comprising synthetic skin and optionally one or more of muscle, connective tissue and fat with each layer adhered to another layer;
   the cassette for holding one or more organ models in anatomical relationships with one another and with the external surface of the housing;
   the cassette having a length of approximately 520 to 530 mm, preferably about 526 mm, and a height of 280 to 300 mm, preferably about 291 mm;
   the cassette comprising a drawer being slidably engageable with the housing so as to be substantially surrounded by it and thereby define a body cavity with it;
   the cover comprising one more of a thermoplastic elastomer, a silicone, a room temperature vulcanizing silicone, a platinum cured room temperature vulcanization silicone; a saturated fatty acid; a pigment, a foam, a cellular or solid polyethylene foam, a solid ethylene vinyl acetate (EVA) foam, a foam comprising air bubbles to provide cellular or tissue texture, a reduced polynomial hyperelastic material, a urethane polymer, a silicone fluid, a deadening agent to soften a silicone component, a platinum cured silicone additive, a silicone oil, an alcohol; a commercial synthetic skin product;
   the synthetic skin sufficiently pliable so as to form a seal around a laparoscopic instrument passing therethrough; and being heat repairable, sufficiently resilient to enable suturing and sufficiently distensible so as to enable life-like expansion when pressure is applied from within the body cavity through insufflation while maintaining said seal;
   the cassette engaging end of the housing comprising a first layer to adhere to a cover, a second layer to define an aperture for entry of the cassette and a third layer comprising a seal to engage in an airtight manner with an external end of the cassette;
   the cassette comprising a drawer with an internal end, a support to hold an organ model, and an external end, the external end comprising a handle and the internal end defining an aperture for passage of an organ model to simulate an anatomical orifice;
   the aperture defined by the closed end of the housing and the aperture defined by the internal end of the cassette arranged so as to form a continuous aperture for passage of an organ model to simulate an anatomical orifice;
   the engagement between the housing and the cassette providing an airtight seal within the body cavity by means of a mechanical locking device the engagement between the housing and the cassette further comprising a seal on the housing and/or a seal on the cassette, the seal(s) comprising a silicon gasket and housed in a channel around the perimeter of the respective engaging parts of the housing and cassette;
   the cassette comprising synthetic bony anatomical features as landmarks, the synthetic bony anatomical features to provide structural integrity for the cover and for anatomical placement and support of said organ models;
   said synthetic bony anatomical features comprising a pelvic model, a rib model and a vertebral model, the pelvic model comprising an engagement means with a slot to provide releasable engagement with a pillar of the inner wall of the organ model support, the pelvic model comprising a cap to fasten a synthetic peritoneal tissue in place;
   the door of the cassette comprising an airtight sealed port for passage of an electrical cable to provide current access for cautery and an airtight sealed port for passage of one or more tubes to provide simulated blood flow access;
   the surgical training apparatus housing and cassette together defining an aperture shaped to receive an aperture-bearing organ model to simulate an anatomical orifice, the organ model further comprising simulated internal anatomy associated with the orifice comprising an organ lumen, the orifice selected from an anal orifice, a vaginal orifice, a penile orifice;
   the aperture-bearing organ model, the housing and the cassette together forming an airtight seal around the simulated orifice so as to enable insufflation of the body cavity while preserving the orifice and associated internal anatomical features;
   the airtight seal around the simulated orifice comprising a flange on the aperture-bearing organ model wherein the flange is within the body cavity and on the inside of the aperture defined by the inner wall of the cassette and the airtight seal further comprising one or more annuli on an insert designed for air-tight fitting engagement with the organ model from outside the body cavity and outside the aperture;
   the insert comprising an annulus for tight fitting engagement with a cover comprising a synthetic skin model to simulate an external orifice selected from an anus, a vulval opening or a penis wherein the external orifice is continuous with the orifice of the aperture bearing organ model within the body cavity;
   the body cavity comprising a hydrogel synthetic pelvic fat pad placed on the pelvic model and adhered to a diathermy pad, the pelvic fat pad to increase anatomical realism and provide a pathway for electrical current to connect with hydrogel tissue during electrocautery;
   the body cavity comprising one or more further organ models selected from: a thoracic organ, a lung, a heart, a thymus, an abdominal organ, a stomach, small intestines, large intestines, a colon, a gall bladder, a rectum, a liver, a pancreas, a spleen, a kidney, an adrenal gland, a bladder, a female reproductive tract, a male reproductive tract, a lymph node, a peritoneal tissue, omentum, mesentery.

In some embodiments, the invention provides a surgical training apparatus comprising a plurality of anatomical landmarks for use during the procedure wherein the anatomical landmarks comprise a synthetic skin overlying an anatomical structure. In some preferred embodiments, the surgical training apparatus is for training a surgical procedure involving a body cavity. In some embodiments it is for training a laparoscopic surgical procedure. In some embodiments, the synthetic skin of the invention comprises one or more anatomical structures. These may for example comprise a skin surface feature which is optionally one or more of a nipple, a fold, hair, a navel, a breast, a vagina, a penis. In some embodiments the synthetic skin of the invention comprises a plurality of additional layers to simulate one or more of muscle, fat and mesentery.

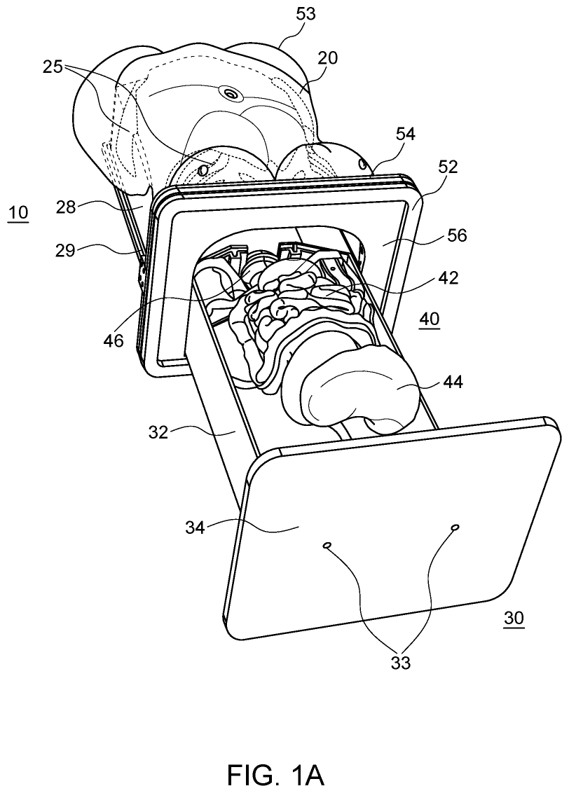

FIG. 1A is an elevated perspective view of an example adult female surgical training apparatus according to the invention shown generally at 10. This particular example comprises a female torso training device and in general terms, comprises the housing 20 and cassette 30. It can be seen that the pelvic and rib bones are shown superimposed at 25 and these can be used in some embodiments to provide structural integrity for example for the external torso, and/or for the internal organs. In some embodiments, the bony structure is 3D printed. Housing 20 is generally shaped to simulate that of an adult female and comprises a cover itself comprising a synthetic material which preferably can simulate skin. Housing 20 comprises side walls 28, a closed end 53 and a cassette-engaging end 54. In this embodiment, the closed end 53 is at the anatomically inferior end of the torso model, and the cassette-engaging end is at the anatomically superior end. It will be appreciated that in some embodiments, the cassette-engaging end may be at the inferior end of the anatomical model and the closed end of housing 20 would be at the anatomically superior end of the model.

Cassette 30 comprises internal end (not shown), support 32 and external end 34. External end 34 comprises attachment points 33 for a handle. Support 32 holds the organ models of interest within cassette 30 so that the surgical training can occur. In this embodiment, support 32 comprises a drawer-like structure which enables the relevant organ models to be placed within the drawer-like structure. However, it is not mandatory that support 32 take the form of a drawer. For example, support 32 may take the form of a series of devices which fix the organ models in an intended anatomical relationship relative to one another for the purposes of the contemplated surgical training procedure.

In this embodiment, cassette-engaging end 54 comprises seal 52 which abuts and engages with external end 34 of cassette 30. In some embodiments, this engagement is air-tight so as to allow the internal chamber defined by cassette 30 and housing 20 to insufflate in order to better simulate surgical conditions and provide the surgeon with an opportunity to practice the techniques required for insufflation. Some embodiments of the invention may not have an airtight seal, so that insufflation cannot be practiced.

In this example embodiment, cassette 30 comprises abdominal organ models 40, including small intestines 42, liver 44 and female reproductive organs 46. In this embodiment, cassette-engaging end 54 comprises 3 layers: a first layer to adhere a synthetic skin-like tissue to; a second layer for the opening door structure to allow the cassette to be inserted and a third layer to provide an airtight fit for the cassette door to insert into and air seal. Cassette engaging end 54 comprises wall 56 which assists to provide a structure for engagement with external end 34 of cassette 30. As discussed above, in some embodiments, this engagement is airtight and may for example be clamped.

The cover of housing 20 may comprise multiple layers so as to simulate the anatomical layers of a body wall, such as an abdominal wall and therefore these layers may comprise one or more layers to simulate muscle, connective tissue, fat and skin. The cover of some embodiments of a torso trainer according to the invention comprise the following: a skin layer, an umbilical stalk, a fat layer, an anterior rectus sheath layer, a first rectus muscle layer, a second rectus muscle layer, a third rectus muscle layer, a posterior rectus sheath layer, a transversalis fascia layer, and a peritoneal tissue layer. One or more of these layers may optionally be created from a hydrogel.

Such layers may be created from a single mould, or may for example be adhered to one another through a technique comprising an adhesive, or welding, compression during moulding, heat annealing, a laminating technique, etc. In some embodiments, merely allowing one or more layers to cure in contact with one or more other layer will provide sufficient adherence or bonding between them. Preferably the layers are adhered to each other as this prevents gaps opening between the layers and provides a more realistic simulation.

Preferably the synthetic skin used in the invention is realistic in texture, colour, elasticity and readily mimics human tissue for procedures such as cutting, suturing, stapling and port placement. In practice a surgeon using the training apparatus can preferably identify the correct position for an incision based on anatomical landmarks of the apparatus. In some preferred embodiments, the skin is sufficiently pliant as to form a seal around a laparoscopic instrument such as a trocar. In some preferred embodiments, the skin is healable by application of heat to the skin surface so that it can be re-used for multiple surgical training sessions. Once a practice surgical procedure is complete, the skin can be heat repaired or ‘healed’ by applying heat to the incision site which causes the edges of the incision to anneal or melt back together. Preferably the heat from a hair dryer is sufficient for this purpose. In some embodiments, a heat gun is used. In some embodiments, the skin is sufficiently resilient to enable suturing without tearing. In some embodiments the cover skin (and any underlying layers) are sufficiently distensible so as to enable life-like expansion of its surface when pressure is applied from within the body cavity through insufflation.

The synthetic skin used in the invention may be made from any suitable materials. The cover layer is preferably moulded in order to achieve the correct anatomical features, such as an umbilical stalk, a navel or nipples, etc. The cover and/or the skin may comprise any one or more of:
an elastomer such as a thermoplastic elastomer;
a silicon such as room temperature vulcanizing silicone for example platinum cured room temperature vulcanization silicone;
a saturated fatty acid;
a pigment
a foam such as a cellular or solid polyethylene foam or a solid ethylene vinyl acetate (EVA) foam, some foams comprise air bubbles to provide cellular or tissue texture;
a reduced polynomial hyperelastic material;
a urethane polymer;
a silicone fluid such as a deadening agent to soften a silicone component, such as a platinum cured silicone additive, or silicone oil;
an alcohol;

In addition, a commercial product may be used to create any one or more of the cover layers including the skin—for example Dragon Skin FX Pro. Such products can be moulded into the required shape and used as part of the cover of housing 20.

### EXAMPLE MOULDS AND MOULDING PROCESS

FIG. 1B is an elevated top perspective view of an example mould for a housing cover for a female surgical training apparatus according to the invention. Mould 70 has outer shell 64 partially constructed over the inner part of the mould 65. In this embodiment, outer shell 64 comprises multiple sections 66, 67, 68, etc. It will be appreciated that outer shell 64 may comprise any number of sections suitable to form a useful housing cover 20. Multiple sections can be joined together, for example as shown where flanges 72 meet. Flanges 72 have corresponding apertures 73 and can be used to hold multiple sections in sealed engagement by fasteners 74 which in this embodiment are simple nuts and bolts.

As this is a female surgical training apparatus, it comprises padding 57 used to simulate the shape of breast tissue for the mould. In addition, it comprises circular section 58, used for moulding the genital region. The shape of the hips is created using part 59 and in particular the ileal wing is created using prominence 60. The shape of the ribs is simulated using rib sections 63. The skin formulation is poured in liquid form so that it fills the space between inner layer 61 and outer shell 64. End sections 62 are provided to seal the end of the mould.

FIG. 1C is an elevated end perspective view of an example mould for a housing cover for a female surgical training apparatus according to the invention. FIG. 1D is an elevated side perspective view of an example mould for a housing cover for a male surgical training apparatus according to the invention.

### EXAMPLE

Dragon Skin FX-Pro made by Smooth-On Inc., is a soft, stable, platinum silicone rubber specifically designed for creating silicone makeup appliances and skin effects. It has a Shore hardness of 2A and can be combined with a deadening agent (such as Slacker made by Smooth-On Inc.) to create a soft silicone gel for filling encapsulated silicone pieces. A chosen skin colour and surface effects can be achieved by adding silicone pigments and if required, painted. It is soft, with a Shore 2A hardness, which allows for softer appliances using less deadening agent. It has low viscosity, which combined with long working time reduces bubbles and makes pouring easier. It cures dry and so will not leach silicone fluid. It has a long working time of 10-12 minutes which is important for larger pours or injections such as the skin cover of the invention. It cures within 40 minutes and has a gel stage which enables the material to be added to moulds more easily.

### Method

1. Prepare the mould, including adding inserts for example to simulate breast tissue, or foam pad(s) to simulate muscle and fat layers. These layers should be placed so that the liquid polymer mixture will fill above them and form a mechanical bond with them and thereby form the cover of housing 20.
2. Pre-mix Part B thoroughly. After dispensing required amounts of Parts A and B into mixing container (1A:1B by volume or weight), mix thoroughly making sure that you scrape the sides and bottom of the mixing container several times.
3. Pour into 3D resin printed mould (for example printed from Siraya Fast Grey resin). Pour the mixture in a single spot at the lowest point of the containment field. Let the rubber seek its own level. A uniform flow will help minimize entrapped air.
4. Allow rubber to cure for 40 minutes at room temperature (73° F./23° C.) before removing from the mould. Do not cure rubber where temperature is less than 65° F./18° C.
5. To finish model once removed from the mould apply heat with heat gun and remove imperfections and bubbles with skin textured silicon pad.

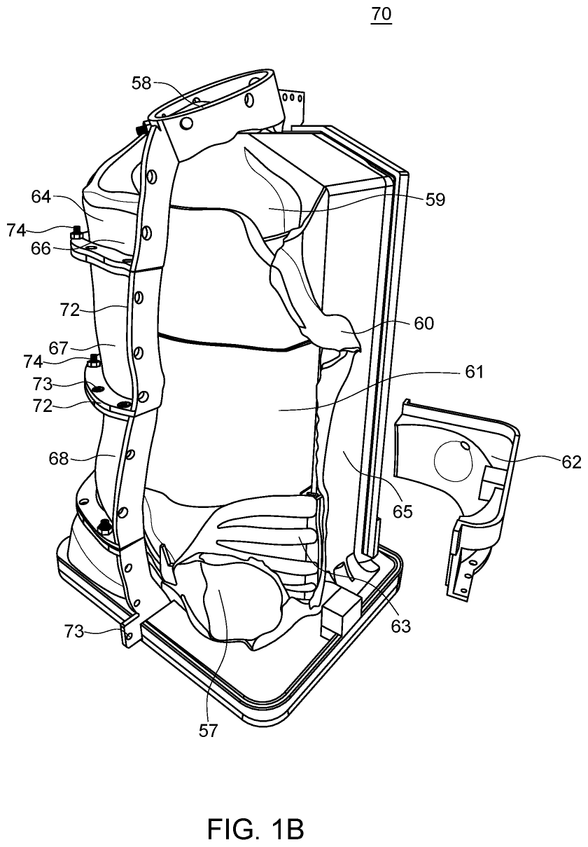

FIG. 2A is an elevated side view of the housing 20 of the adult female surgical training apparatus of FIG. 1. It can be seen that the pelvic and rib bones are shown superimposed at 25 and these can be used in some embodiments to provide structural integrity for example for the external torso, or for the internal organs. Some embodiments comprise additional bony features to enable further landmarks and realism. For example, some embodiments comprise additional appendicular skeletal bony landmarks, such as those from the scapular, clavical, etc. Some embodiments comprise limb joints which may have artificial limbs attached thereto. This additional realism enables training opportunities to be extended beyond surgeons to other support staff, such as theatre nurses or orderlies or anaesthetists. Some embodiments comprise one or more limbs attached to the torso at anatomically correct locations. In some of these embodiments the limbs are adapted for life-like range of movement. By providing a training apparatus with additional features such as limbs or a neck and head a more realistic theatre training environment can be created. This may for example include training in placement of the patient on the table relative to the robot and/or access to the patient by theatre staff while avoiding the robot and the surgeon.

The external surface or cover 230 of housing 20 is generally shaped to simulate that of an adult female and comprises a cover of synthetic material which can preferably simulate skin. Housing 20 comprises tray 29, side walls 28, a closed end 53 and a cassette-engaging end 54. Tray 29 and side walls 28 function to provide an enclosed space for cassette 30 to sit within so as to simulate normal anatomical structures and make it easier to ensure that space is airtight. The external surface 230 of closed end 53 of housing 20 comprises an aperture 220 which is in the shape of an anatomical orifice (in this case the vulval opening). In this embodiment, the closed end 53 is at the anatomically inferior end of the torso model, and the cassette-engaging end is at the anatomically superior end. This embodiment comprises block 200 which is attached to cassette-engaging end 54. Block 200 facilitates attachment of a clamp between it and external end 34 of the cassette to enable an airtight seal. Flange 210 is part of the attachment of the cassette 30 to external end 34 of the cassette.

FIG. 2B is an elevated side view of an example housing for an adult male surgical training apparatus. It can be seen that the pelvic and rib bones are shown superimposed at 25 and these can be used in some embodiments to provide structural integrity for example for the external torso, or for the internal organs. The external surface 230 of housing 20 is generally shaped to simulate that of an adult male and comprises a covered of synthetic material which can preferably simulate skin. Housing 20 comprises tray 29, side walls 28, a closed end 53 and a cassette-engaging end 54.

Tray 29 and side walls 28 function to provide an enclosed space for cassette 30 to sit within so as to simulate normal anatomical structures and make it easier to ensure that space is airtight. The external surface 230 of closed end 53 of housing 20 comprises an aperture 220 which is in the shape of an anatomical orifice (in this case the urethral opening of the penis). In this embodiment, the closed end 53 is at the anatomically inferior end of the torso model, and the cassette-engaging end is at the anatomically superior end.

FIG. 2C is an elevated side view of an example housing for a further adult male surgical training apparatus. It will be appreciated that people have a variety of body shapes which can themselves present additional challenges for a variety of surgeries. For example, identification of anatomical landmarks (such as bony prominences) may be hindered, and subcutaneous fat can bulge into a surgical site or get in the way of the passage of surgical instruments. Accordingly, in this example embodiment, the male torso has the characteristics of a mildly obese adult male. In this embodiment, the pelvic and rib bones are not shown superimposed. The external surface 230 of housing 20 is generally shaped to simulate that of a slightly obese adult male and comprises a covered of synthetic material which can preferably simulate skin. Housing 20 comprises tray 29, side walls 28, a closed end 53 and a cassette-engaging end 54. Tray 29 and side walls 28 function to provide an enclosed space for cassette 30 to sit within so as to simulate normal anatomical structures and make it easier to ensure that space is air tight. This embodiment comprises block 200 which is attached to cassette-engaging end 54. Block 200 facilitates attachment of a clamp between it and external end 34 of the cassette to enable an airtight seal. The external surface 230 of closed end 53 of housing 20 comprises an aperture 220 which is in the shape of an anatomical orifice (in this case the urethral opening of the penis). In this embodiment, the closed end 53 is at the anatomically inferior end of the torso model, and the cassette-engaging end is at the anatomically superior end.

FIG. 2D is an elevated side view of an example housing for a still further adult male surgical training apparatus. Iin this example embodiment, the male torso has the characteristics of an obese person. In this embodiment, the pelvic and rib bones are not shown superimposed. The external surface 230 of housing 20 is generally shaped to simulate that of an obese adult male and comprises a covered of synthetic material which can preferably simulate skin. Housing 20 comprises tray 29, side walls 28, a closed end 53 and a cassette-engaging end 54. Tray 29 and side walls 28 function to provide an enclosed space for cassette 30 to sit within so as to simulate normal anatomical structures and make it easier to ensure that space is airtight. The external surface 230 of closed end 53 of housing 20 comprises an aperture 220 which is in the shape of an anatomical orifice (in this case the urethral opening of the penis). In this embodiment, the closed end 53 is at the anatomically inferior end of the torso model, and the cassette-engaging end is at the anatomically superior end.

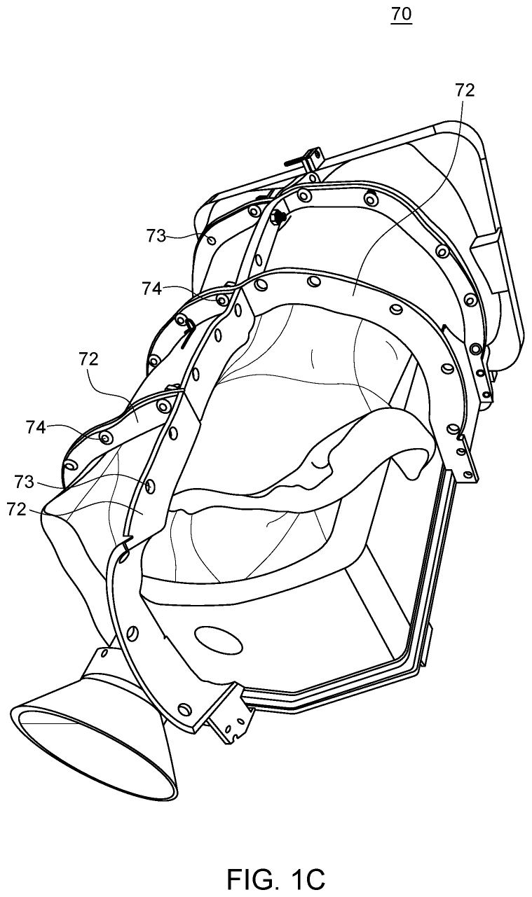

FIG. 3 is an elevated end view of the housing of the adult female surgical training apparatus of FIG. 1. In this view, cavity 315 of housing 20 is readily visible as well as floor 310 and the internal view of wall 28. Cavity 315 is clearly represented in this view and is defined by closed end 53, an aperture 320 of cassette engaging end 54, walls 28 and floor 310. Wall 56 of cassette engaging end 53 defines aperture 320 through which a cassette (which, in use may be preloaded with organ models) can be loaded.

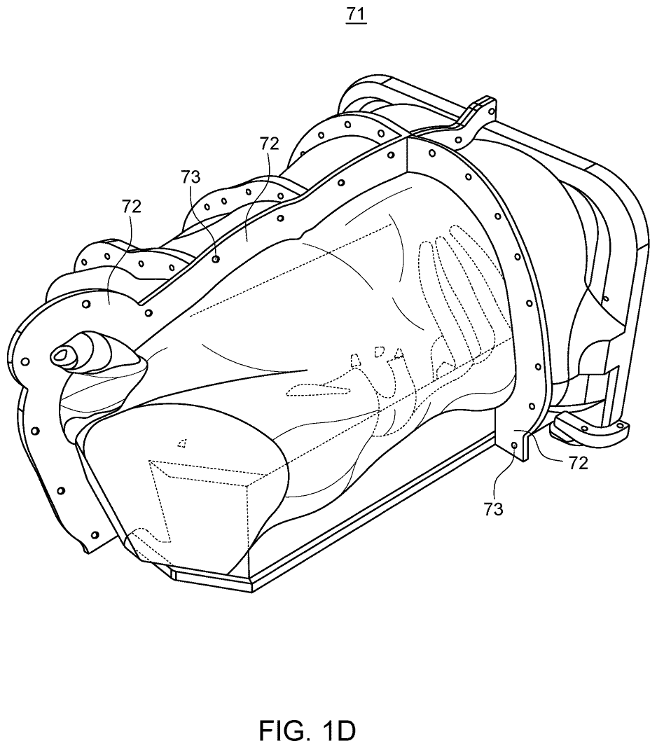

FIG. 4 is an elevated side view of the housing from the adult female surgical training apparatus of FIG. 1 without the external surface 230 fitted. In this view, housing 20 comprises pelvic and rib bones 25 which have been 3D printed, but no other organs. Closed end 53 comprises an aperture 400 so that a female reproductive tract organ model can be fitted if required. It will be appreciated that aperture 400 is continued through aperture 220 as shown in FIG. 2 in order to simulate the anatomical orifice (vulval opening). Preferably, aperture 400 is able to be engaged in an airtight manner with such an organ model so that the training apparatus can be used to practice insufflation techniques.

Cavity 315 is clearly represented in FIG. 4 and is defined by closed end 53, aperture 320 of cassette engaging end 54, walls 28 and floor 310 of tray 29. The generally rectangular-prism shape of cavity 315 of this embodiment is designed for convenience as it broadly mimics the anatomy, and to simplify the actions of fitting and removing the various organ models. The angle of closed end 53 represents the truncated torso shape with the legs removed to mimic the pelvis. It will be appreciated that in some embodiments cavity 315 more closely simulates the internal three dimensional shape of the chest and abdominal cavities, as for example in this case, of an adult female human.

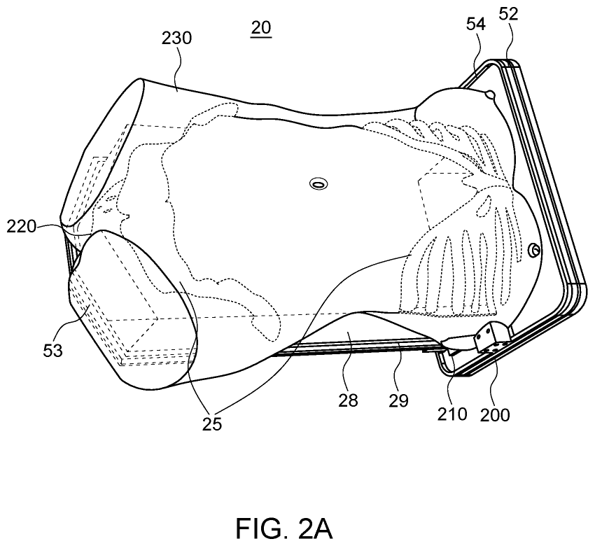

FIG. 5 is an elevated side view of an example cassette from a surgical training apparatus according to the invention. Cassette 30 comprises support 32, internal wall 530 and external wall 34. Support 32 is designed to be reversibly engageable with an organ model within the cassette. In this embodiment, support 32 comprises a generally rectangular prism-shaped vessel which defines cavity 550 within which organ models can be placed for surgical training. Cavity 550 is defined by support floor 520, internal wall 530 and external wall 560 at external end 34 of cassette 30. Internal wall 530 defines an aperture 510 so that in this example, a female reproductive tract organ model can be fitted if required. It will be appreciated that aperture 510 is continued through aperture 400 of housing 20 (see FIG. 4) which is continued through aperture 220 as shown in FIG. 2 in order to simulate the anatomical orifice (vulval opening). Preferably, apertures 400 and 510 are able to be engaged in an airtight manner with such an organ model so that the training apparatus can be used to practice insufflation techniques. External end 34 of cassette 30 also comprises panel 540 which can be used to seal and engage with cassette-engaging end 54 of housing 20, for example with seal 52.

It will be appreciated that support 32 may be designed in a variety of ways provided that it is reversibly engageable with an organ model within cassette 30. For example, it may comprise one or more elements which grasp and hold one or more organ models in a predetermined anatomical relationship with each other and with respect to cassette 30 and housing 20. Accordingly, in some embodiments, cassette 30 may not comprise a generally rectangular prism shape. Similarly, although cassette 30 is substantially drawer shaped in this embodiment, it will be appreciated that this is not required in order for it to fulfil its function of providing a structure for removable engagement of one or organ models within housing 20 such that they are surgically accessible through housing 20.

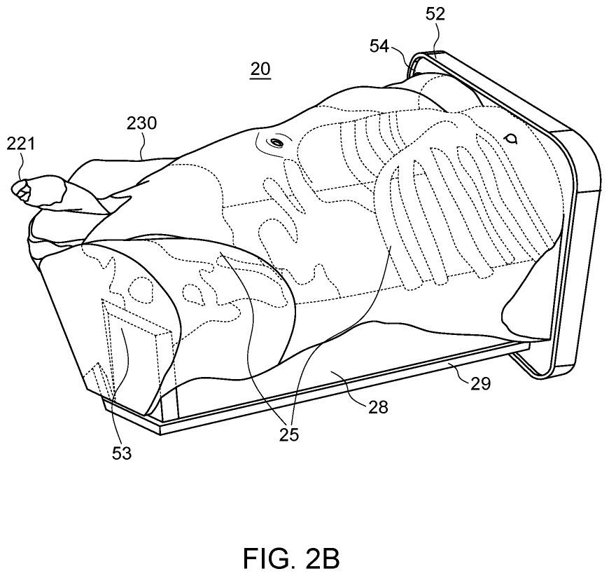

FIG. 6 is an elevated side view of the cassette of FIG. 5 with a pelvic model inserted. In this embodiment, pelvic model 600 is placed so as to anatomically simulate an underlying bone or bony structure, being the pelvis. Pelvic model 600 is placed so as to provide a structure for the shape of the external surface 230 to simulate a portion of human or animal anatomy (see item 25 in FIGS. 1, 2 and 3). Pelvic model 600 comprises an engagement means 630 to provide releasable engagement with support 32. In this embodiment, engagement means 630 abuts wall 530 which has a pillar 633 for wall rigidity to reduce movement and ensure air seal. In this embodiment, engagement means 630 provides slidable engagement between support 32 and pelvic model 600. However, other forms of simple mechanical engagement are equally applicable, for example keyhole, latch, screw, press stud, latch and hook, etc.

The engagement between wall 620 and pelvic support 610 to provide releasable but stable positioning within support 32. Pelvic support 610 is designed to assist in locating a cap which can be placed on the pelvic model 600 to fasten a synthetic peritoneal tissue in place. Pelvic support 610 assists to align fixtures such as bolts that fasten or sandwich the peritoneal tissue in the correct position. As used herein, the term ‘peritoneal tissue’ may include any one or more of the following: a peritoneum (or peritoneal lining), an omentum, a mesentery or other intra-peritoneal tissue. Wall 620 ensures the pelvis abuts the internal wall 530 and locates the correct position for bolts and also adds rigidity for an air seal. In this embodiment, engagement means 630 comprises pillar 633 of internal wall 530 and slot 632 of pelvic model 600.

Pillar 633 also provides for wall rigidity to reduce movement and ensure air seal. Pelvic model 600 can be produced by any suitable means, for example, it may be moulded from plastic, or printed with a three dimensional printer. Preferably it comprises a hard material, such as a plastic or a metal alloy, so that it can simulate bone and provide rigid structure for abdominal organs to be placed in anatomical position within support 32. More preferably, bony structures comprise one or more of rigid plastics and optionally PVC, resin, poly-carb, poly propylene and the like.

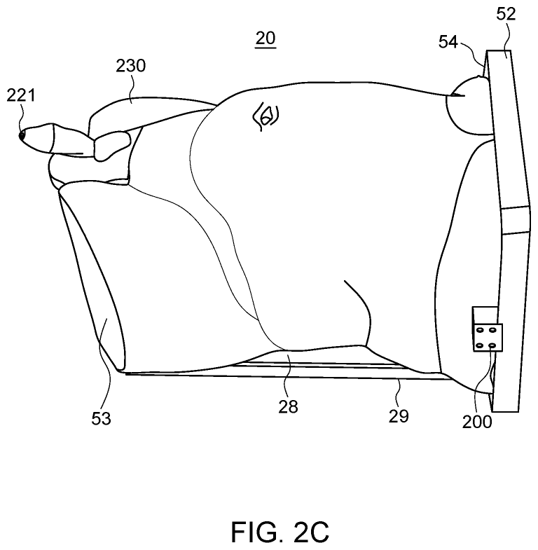

FIG. 7 is an elevated side view of the cassette of FIG. 6 with a pelvic fat base model 700 inserted. It can be seen that pelvic fat base model 700 is inserted into the pelvic canal in order to simulate anatomical fat in this region. Model 700 is preferably made from a conductive and flexible material, and preferably it is made from a material that simulates fat in its handling characteristics. In preferred embodiments, model 700 connects the hydrogel organs with the diathermy lead to enable electro cautery. Additional functions for model 700 include aesthetic and anatomic realism.

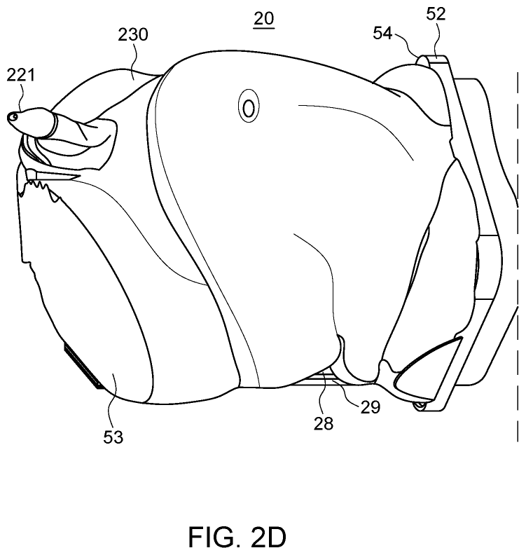

FIG. 8 is an elevated side view of the cassette of FIG. 7 with a uterine model 800 inserted. Uterine model 800 comprises uterine body 810, uterine horn 820 and vaginal region 830. Vaginal region 830 comprises an engagement portion for engagement with the parts of cassette 30 and housing 20 which define apertures 400 and 510. It may also engage with aperture 220 of external surface 230 and with part of pelvic model 600 (for example engagement means 630).

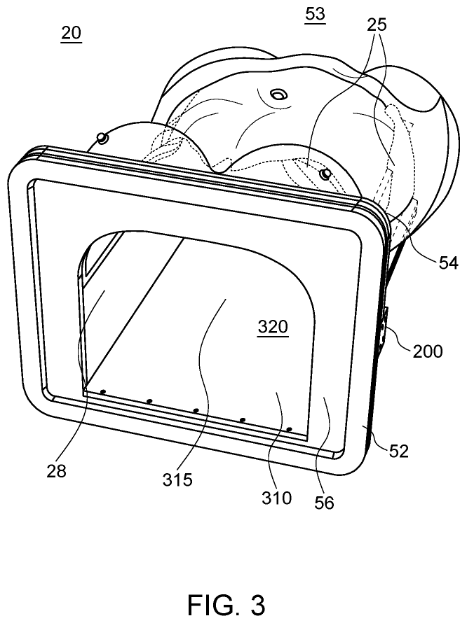

FIG. 9 is a close-up of the cassette of FIG. 8 to show more detail of the organ models. This Figure in particular shows more detail in relation to engagement portion 900 of vaginal region 830 of uterine model 800. It will be appreciated that aperture 910 of insert 950 and thereby of uterine organ model 800 maintains continuous contact with the lumen of uterine model 800 as well as apertures 510, 400 and 220 and thereby enables simulation of the internal lumen of the female reproductive tract from housing 20, through pelvic model 600, through cassette 30 to uterine model 800. Engagement by engagement portion 900 of vaginal region 830 with aperture 510 (and in some embodiments, the relevant part of pelvic model 600) may be by any suitable means able to provide sufficient fit for the purpose at hand. For example, in some embodiments it must be able to provide a water-tight seal, and in some it must be able to provide an airtight seal. In some it may be sufficient to be structurally sound without a seal. In the present embodiment, engagement portion 900 of vaginal region 830 of uterine model 800 comprises flange 930 and insert 950. Flange 930 abuts aperture defining portion 631 of pelvic model engagement means 630 so as to restrict movement of the uterine organ model 800 outward through aperture 510. Insert 950 comprises annulus 920 which abuts the exterior of internal wall 530 and is inserted through flange 930 into vaginal region 830 in tight fitting engagement. The close abutment of annulus 920 with the exterior of internal wall 530 ensures that uterine organ model 800 can not slip inwards into cavity 550 and away from aperture 510. Insert 950 further comprises secondary annulus 940 which can be fittingly engaged with an external surface 230, so as to enable continuation of aperture 910 through to aperture 220. In an alternative embodiment, aperture 910 and flange 930 can be replaced with a single ringed annulus which has no internal aperture to seal the torso for insufflation to prevent air escaping through the vaginal orifice. In the case of the pelvis not being in the model, the single ring annulus allows other alternative cartridges to be inserted.

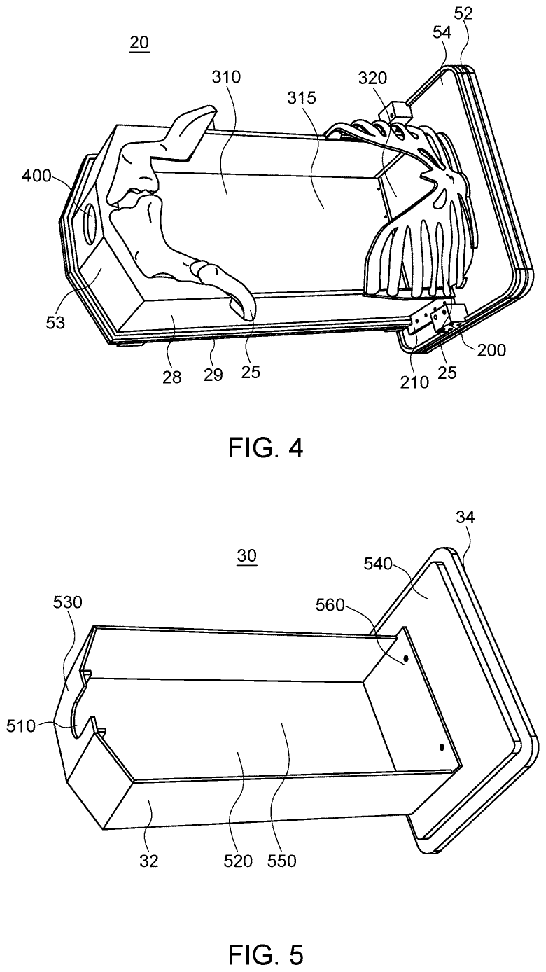

FIG. 10 is a side diagrammatic representation of an example cassette according to the invention in accordance with FIG. 8. This Figure provides some suggested dimensions for a typical human adult female torso surgical training apparatus. A cassette length of approximately 520 to 530 mm, preferably about 526 mm, and cassette drawer height of 280 to 300 mm, preferably 291 mm has proven beneficial in terms of ease of manufacture and use for surgical training. It will be appreciated that other dimensions commensurate with the normal range of anatomical dimensions of the surgical patient to be simulated will be suitable.

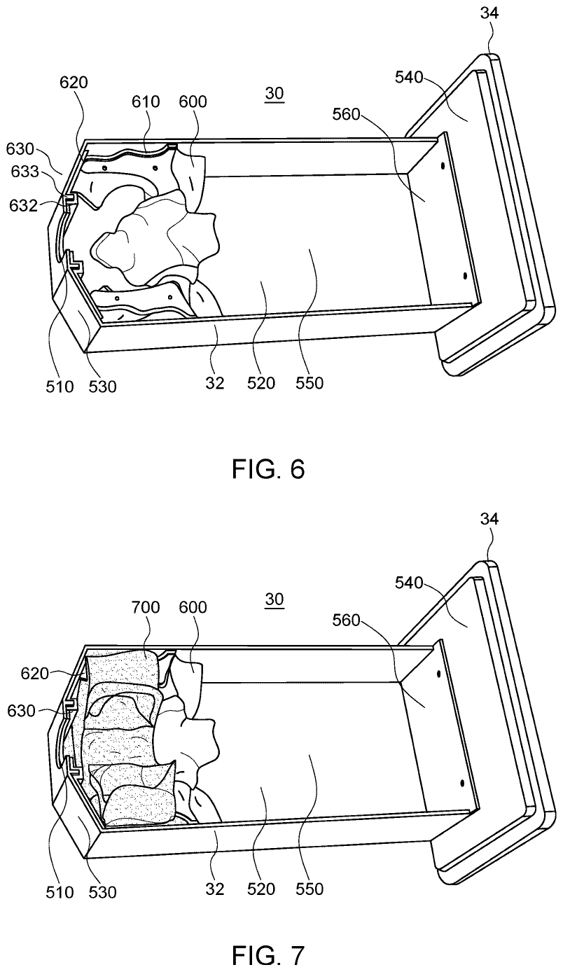

FIG. 11 is an elevated side view of the cassette of FIG. 6 with additional organ models inserted. In particular, small intestines 42, large intestines 1110, stomach 1120 and liver 44. It will be appreciated from FIG. 11 that a more accurate anatomical relationship between the various organ models can be achieved by variations in support 32. For example, a slight modification to the current exemplified embodiment would be to shape support floor 520 to simulate that of the posterior shape of the abdominal and thoracic cavities. In another example embodiment, the entirety of cavity 550 is shaped to so simulate the abdominal cavity. In yet another example embodiment, support 32 may comprise one or more devices to hold each organ model in a particular anatomical position.

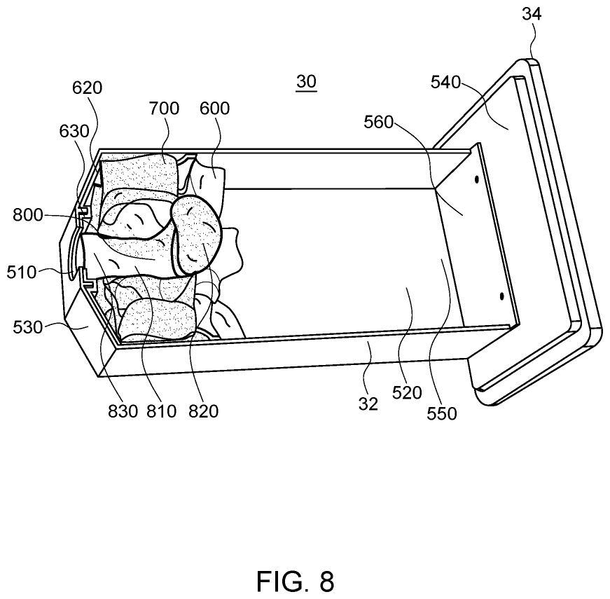

FIG. 12 is an elevated perspective view of an example paediatric surgical training apparatus according to the invention shown generally at 1210 with the cassette open. In general terms, this embodiment comprises housing 1220 and cassette 1230. Housing 1220 is generally shaped to simulate that of a paediatric patient and covered in a synthetic material which can for example simulate skin. Housing 1220 comprises tray 1229, side walls 1228, a closed end 1253 and a cassette-engaging end 1254. Tray 1229 and side walls 1228 function to provide an enclosed space for cassette 1230 to sit within so as to simulate normal anatomical structures and make it easier to ensure that space is airtight. In this embodiment, the closed end 1253 is at the anatomically inferior end of the torso model, and the cassette-engaging end is at the anatomically superior end. It will be appreciated that in some embodiments, the cassette-engaging end may be at the inferior end of the anatomical model and the closed end of housing 1220 would be at the anatomically superior end of the model.

Cassette 1230 comprises internal end (not shown), support 1232 and external end 1234. External end 1234 comprises handle 1233. In this embodiment, handle 1233 is shaped so as to facilitate operation of an air locking wheel to create an airtight cavity within the housing. Support 1232 holds the selected organ models within cassette 1230 so that the surgical training can occur. In this embodiment, support 1232 comprises a drawer-like structure which enables the relevant organ models to be added and sit within the drawer-like structure. However, it is not mandatory that support 1232 take the form of a drawer. For example, support 1232 may take the form of a series of devices which fix the organ models in an intended anatomical relationship relative to one another for the purposes of the contemplated surgical training procedure.

In this embodiment, cassette-engaging end 1254 comprises seal 1252 which abuts and engages with external end 1234 of cassette 1230. Channel 1255 provides a channel shaped cavity to receive an air seal which may for example comprise a soft plastic, rubber, or similar material such as silicon. Frame 1252 is the inner door frame structure and facilitates an air sealed engagement. In some embodiments, this engagement is air-tight so as to allow the internal chamber defined by cassette 1230 and housing 1220 to insufflate in order to better simulate surgical conditions and provide the surgeon with an opportunity to practice the techniques required for insufflation. Some embodiments of the invention may not have an airtight seal, so that insufflation cannot be practiced.

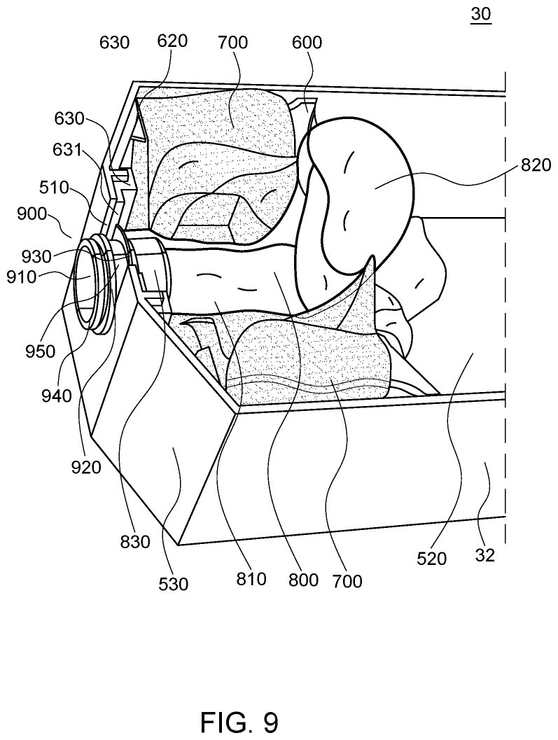

In this example embodiment, cassette 1230 comprises abdominal organ models 1240, including small intestines 1242, liver 1244 and large intestines 1243. In this embodiment, cassette-engaging end 1254 comprises 3 layers: a first layer to adhere a synthetic skin-like tissue to; a second layer for the opening door structure to allow the cassette to be inserted and a third layer to provide an airtight fit for the cassette door to insert into and air seal. This particular embodiment comprises a mechanical air lock built into the space between inner wall 1260 and outer door 1234 of cassette 1230. Rotation of handle 1310 (see FIG. 13) rotates the teeth on cog 1262 which in turn engage the air lock using teeth 1266 and 1264. FIG. 13 is another elevated perspective view of the paediatric surgical training apparatus of FIG. 12.

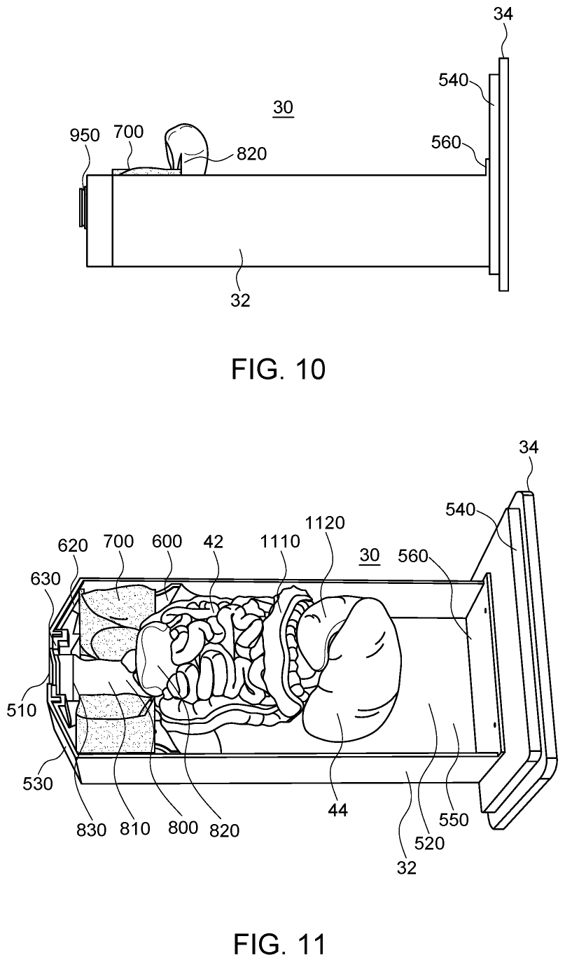

FIG. 14 is an elevated perspective view of a paediatric surgical training apparatus which is similar to that of FIG. 12 with the cassette closed. It will be appreciated that in this embodiment, handle 1410 of external end 1234 of cassette 1230 comprises a simple knob. Any suitable handle can be used for this purpose, provided that it is able to be readily grasped for inserting and removing the cassette 1230 within housing 1220. FIG. 14 also shows clasp 1420 which is used to fasten cassette 1230 to housing 1220 in close proximity, and in some embodiments with an airtight seal.

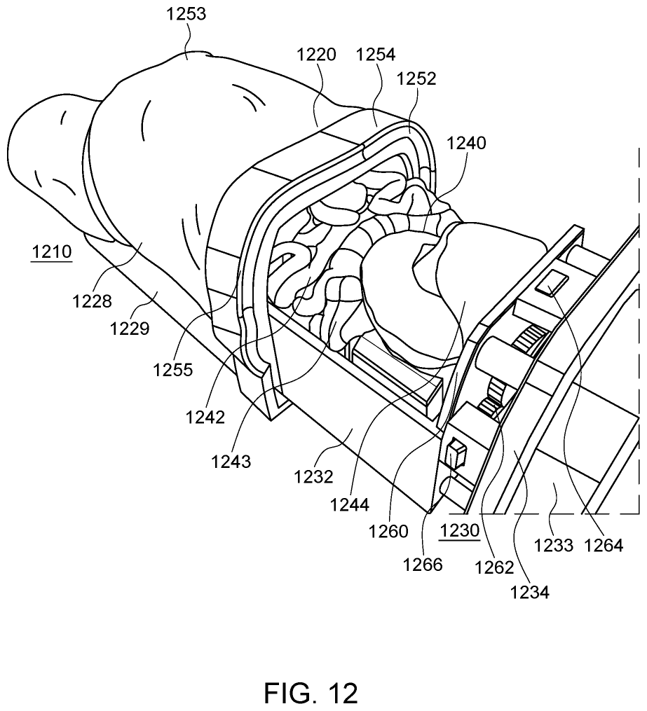

FIG. 15 is an elevated perspective view of an example paediatric surgical training apparatus of FIG. 13 with the cassette removed. FIG. 15 depicts brackets 1510 with which clasps 1420 engage in order to fasten cassette 1230 to housing 1220. FIG. 15 also depicts organ models 1520 which are comprised of different materials to those depicted earlier, as is evident by their appearance. They comprise Liver 1530, stomach 1540, large intestines 1550 and small intestines 1560.

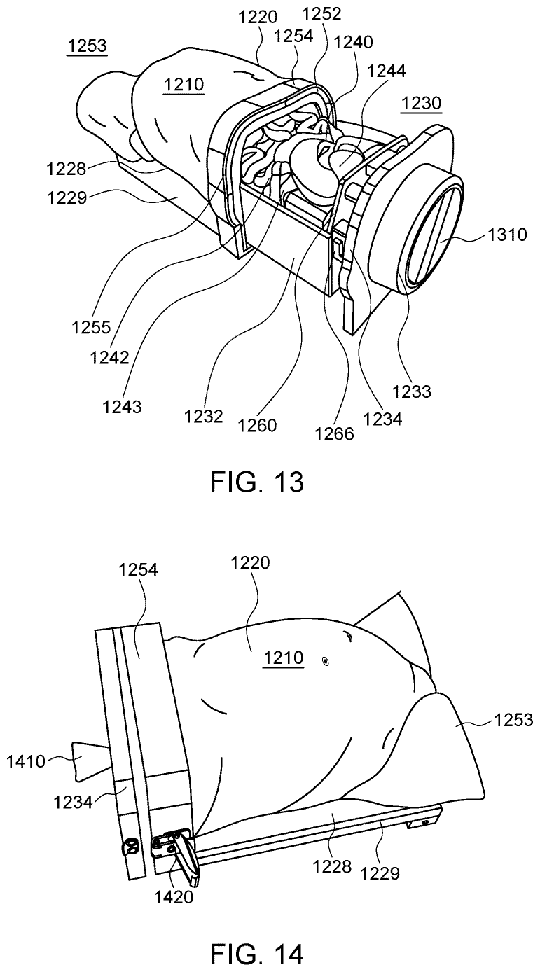

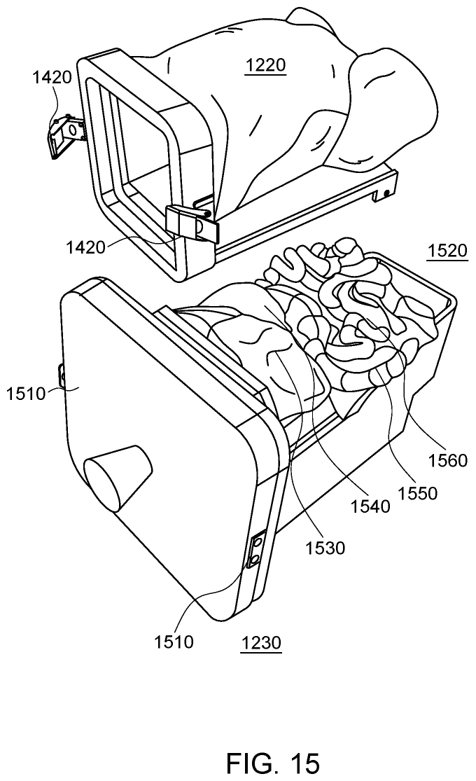

FIG. 16 is an elevated perspective view of the paediatric surgical training apparatus of FIG. 13 with the cassette partially open. FIG. 17 is an elevated perspective view of the paediatric surgical training apparatus of FIG. 15 with abdominal organs removed. FIG. 17 depicts bony structure 1710 which in this instance is in the general shape of the pelvic girdle so as to provide a structure for the organ models and assist to maintain them in approximate anatomical positions relative to each other when inserted in cassette 1230.

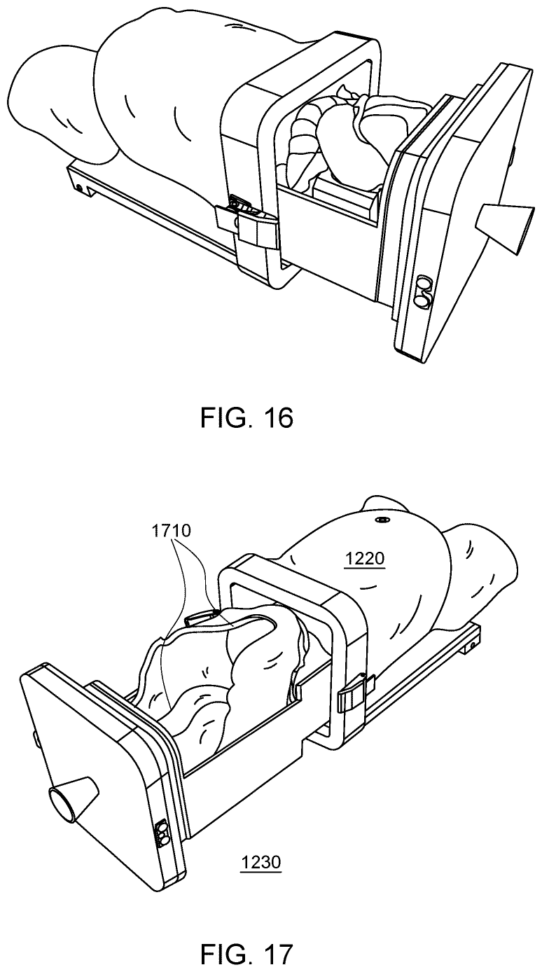

FIG. 18 is an elevated perspective view of the surgical training apparatus of FIG. 17 with organs assembled separately and spare stomachs 1810. This embodiment provides insert 1820 on which the organ models are placed to assist to maintain them in approximately accurate anatomical relationship. Insert 1820 can be readily placed in engagement with support 1232, and in the present case this means into cassette 1230.

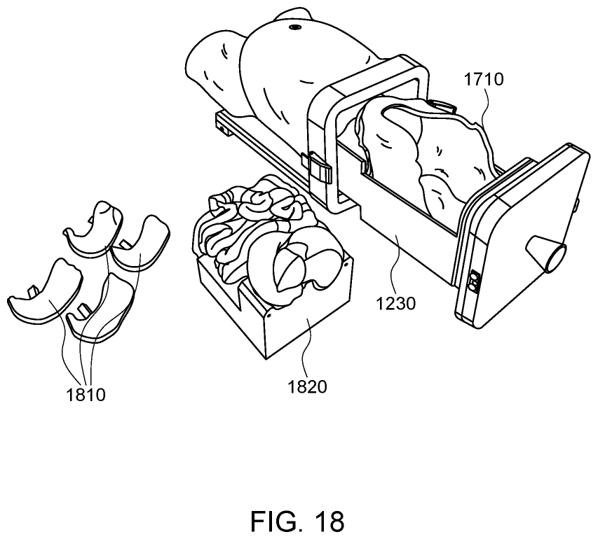

FIG. 19 is an elevated perspective view of a cassette according to the invention shown generally at 1930 suitable for use as a paediatric training device. It will be appreciated that in this embodiment, pelvis 1910 and ribs 1920 are pre-attached to cassette 1930. This may be done in any suitable manner, for example they may be fixed with an adhesive, or screws or clips or by ‘snap fitting’ pre designed sections or by moulding parts of the cassette or support with the bony structures. This embodiment simplifies certain procedures, for example it is not necessary to insert pelvic or rib organ models before inserting other organ models. The pelvis and ribs provide structural integrity for the other organ models and assist to maintain them in generally more accurate anatomical locations. Similarly, it will be appreciated that simulation of such bony structures assists the surgeon to simulate a real surgery as they present similar landmarks and obstacles and tactile or other sensory responses when interacting with the training device.

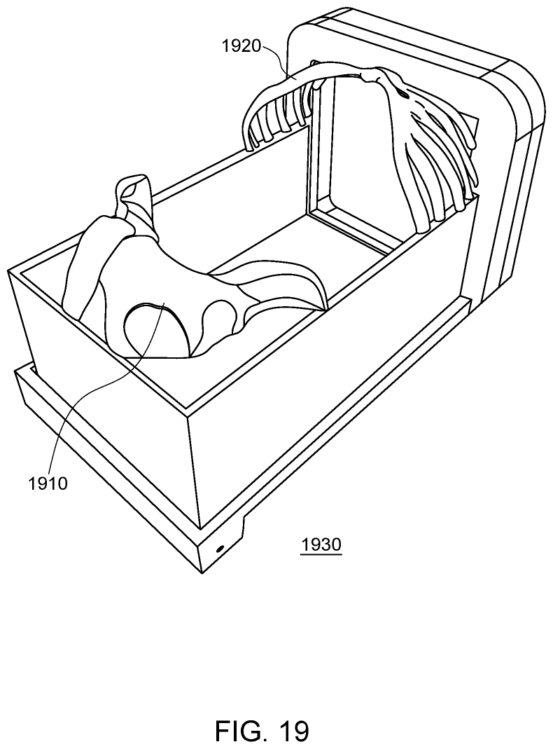

FIG. 20 is an elevated perspective view of the cassette of FIG. 19 with vertebrae 2030 and inguinal hernia model inserted. Vertebrae 2030 provide further simulation for appropriate anatomical organ placement. Structure 2010 is a pelvic cap that slides over the embedded solid pelvis to make a unified pelvis. Structure 2020 represents the inguinal ligament under which the hernia model sits.

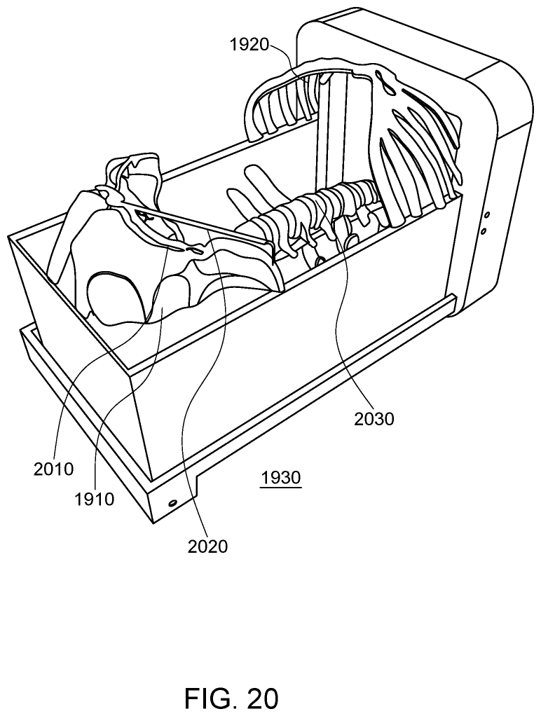

FIG. 21 is an elevated perspective view of the cassette of FIG. 20 from a different angle. In this embodiment, the cassette has been engineered to match the existing solid pelvis, which slides over it like a sheath. This embodiment is custom designed to fit tightly the solid pelvis to allow a surgical hernia repair procedure to be conducted.

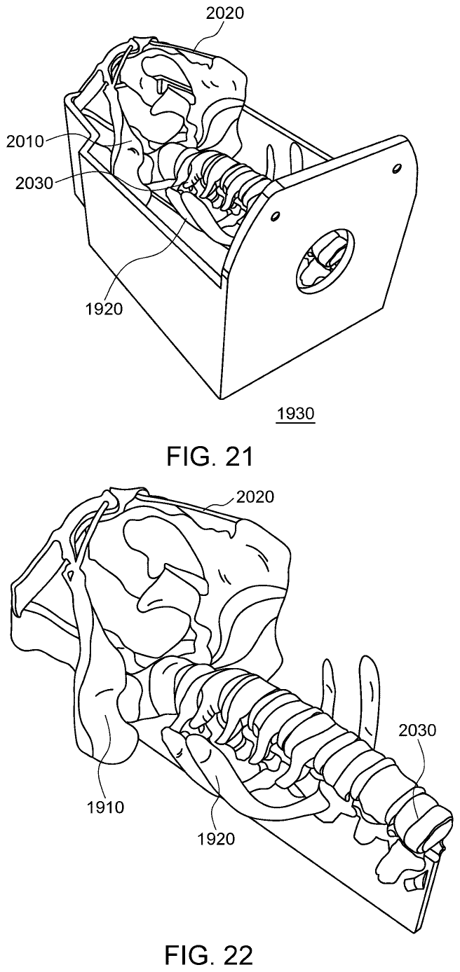

FIG. 22 is an elevated perspective view of assembled pelvis, vertebrae and inguinal hernia models according to the invention. To create an inguinal hernia repair training model, this part can be inserted into a mould and have a synthetic skin applied around it so that it is embedded in the material with the inguinal hernia defect sitting between the inguinal ligament and pelvic position.

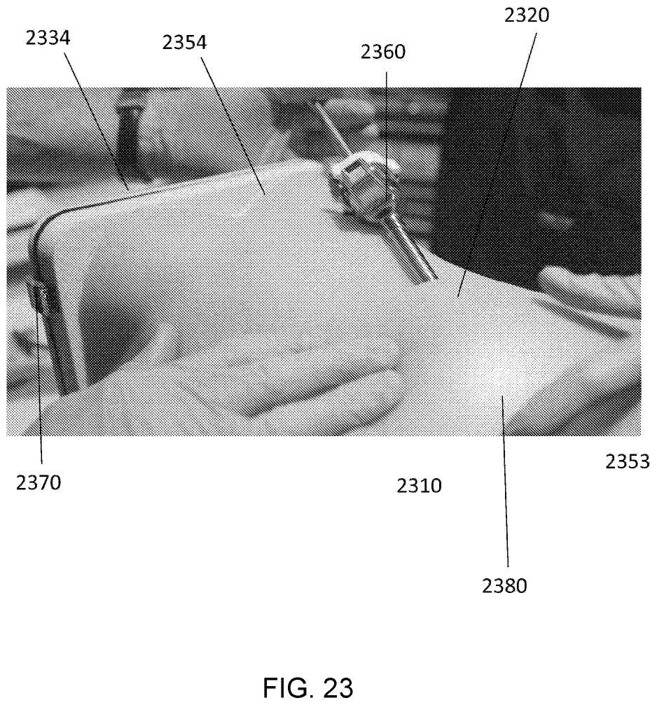

FIG. 23 is a photographic image of a surgical training apparatus of the invention in use shown generally at 2310. Apparatus 2310 comprises housing 2320 with closed end 2353 and a cassette-engaging end 2354. External end 2334 of the cassette is visible as is clasp 2370 which is used to engage and hold the cassette in airtight seal with housing 2320. Housing 2320 is covered in an external layer intended to simulate skin. The surgical team undergoing training is surgically accessing the underlying organ models (not shown) through housing 2320 by use of trocar 2360. The light shone by surgical camera via trocar 2360 underneath the external layer of housing 2320 is evident at 2380.

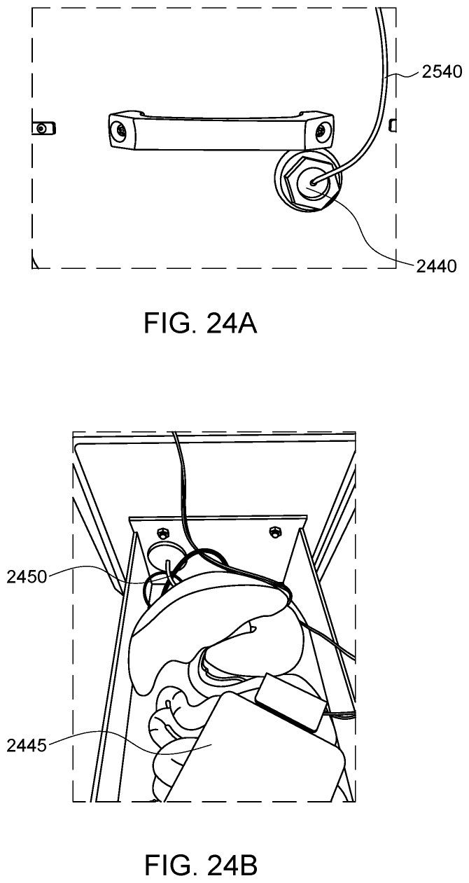

FIG. 24a shows the external door structure and a silicone sealed aperture 2440 through which an electrical cable 2540 for diathermy and a perfusion tube (not shown) can be inserted. FIG. 24b shows the internal door structure of FIG. 24a. The internal end 2450 of cable 2450 is attached to the diathermy pad 2445 which is in close contact with and preferably adhered to the hydrogel ‘fat pads’ 700 (See FIG. 7) at the base of the pelvis connecting all of the synthetic tissue. The external end (not shown) of cable 2540 comprises a connection for the diathermy machine socket. Electrical wires 2540 can be seen entering through aperture 2440. Also vessels can be perfused with synthetic blood by running tubing (for example medical grade) through aperture 2440. The external end of tube may have a universal connector to which a reservoir such as an intravenous bag can be connected to gravity feed a blood flow. In addition a pump can be used to provide higher pressure of artificial blood, for example to simulate an artery.

In use, a training apparatus according to the invention can be prepared by selecting which procedural synthetic model to use, opening the cassette drawer and placing it in an anatomically correct position. The diathermy pad is placed and connected to the fat pad to allow electric current to flow. The medical tubing is inserted through the aperture and connected to vessels to allow perfusion. The internal end of the tubing would connect to the external end of the vessel extruding from the organ. The cassette would then be closed and latched or locked into position within the housing/pelvic structure.

The trainee would first make an incision in the umbilical region of the torso and insert a trocar into the abdomen to enable insertion of the insufflation device and camera port which would connect to external machines. They would then turn on the gas to insluffate the cavity and thereby create a space to insert instruments. Using the vision from the camera they would insert a trocar into other locations to allow instrument ports to be placed safely into the torso abdomen. The diathermy would be switched on allowing electrocautery and the blood flow would be turned on to allow perfusion when a vessel is cut or compromised. They would then proceed to conduct surgical steps according to the procedure and model.

1. A surgical training apparatus comprising a housing and a cassette:
the housing comprising a synthetic layer to simulate skin;
the cassette for holding one or more organ models in anatomical relationships with one another;
the cassette engageable with the housing so as to be substantially surrounded by it and thereby define a body cavity with it;
the cassette comprising synthetic bony anatomical features as landmarks.

2. A surgical training apparatus according to claim 1 wherein the cassette comprises a drawer being slidably engageable with the housing.

3. (canceled)

4. A surgical training apparatus according to claim 1 wherein the housing is substantially covered on an operable surface by a cover which comprises a synthetic layer to simulate skin.

5. A surgical training apparatus according to claim 4 wherein the synthetic bony anatomical features provide structural integrity for the cover and for anatomical placement and support of said organ models.

6. A surgical training apparatus according to claim 5 wherein the housing is shaped externally to mimic a life sized torso.

7. (canceled)

8. A surgical training apparatus according to claim 7 wherein the housing comprises a side wall and a closed end and the closed end of the housing comprising a cassette-engaging end defining an aperture to receive the cassette.

9. A surgical training apparatus according to claim 8 wherein the synthetic skin is sufficiently pliable so as to form a seal around a laparoscopic instrument passing therethrough.

10. A surgical training apparatus according to claim 9 wherein the engagement between the housing and the cassette provides an airtight seal within the body cavity by means of a mechanical locking device.

11. A surgical training apparatus according to claim 10 wherein:
the synthetic skin is heat repairable, sufficiently resilient to enable suturing and sufficiently distensible so as to enable life-like expansion when pressure is applied from within the body cavity through insufflation while maintaining said seal;
the body cavity comprises a hydrogel synthetic pelvic fat pad placed on the pelvic model.

12. A surgical training apparatus according to claim 11 wherein:
the synthetic bony anatomical features comprise one or more of a pelvic model, a rib model and a vertebral model;
the hydrogel synthetic pelvic fat pad placed on the pelvic model is adhered to a diathermy pad, the pelvic fat pad to increase anatomical realism and provide a pathway for electrical current to connect with hydrogel tissue during electrocautery.

13. A surgical training apparatus according to claim 12 wherein:
the cassette comprises a drawer with an internal end, a support to hold an organ model, and an external end, the external end comprising a handle;
the engagement between the housing and the cassette further comprising a seal on the housing and/or a seal on the cassette.

14. (canceled)

15. A surgical training apparatus according to claim 1 wherein the engagement between the housing and the cassette further comprises a seal on the housing and/or a seal on the cassette, each seal optionally comprising a silicon gasket and each seal optionally housed in a channel around the perimeter of the respective engaging parts of the housing and cassette;
the door of the cassette comprises an airtight sealed port for passage of an electrical cable to provide current access for cautery and an airtight sealed port for passage of one or more tubes to provide simulated blood flow access.

16. A surgical training apparatus according to claim 15 wherein:
the housing further comprises a tray and a side wall;
the housing is shaped externally to mimic a life sized torso and substantially covered on an operable surface by a cover which comprises one or more synthetic layers to simulate a body wall, the synthetic layers comprising synthetic skin and optionally one or more of muscle, connective tissue and fat with each layer adhered to another layer;
the cover comprises one more of an elastomer, a thermoplastic elastomer, a silicone, a room temperature vulcanizing silicone, a platinum cured room temperature vulcanization silicone; a saturated fatty acid; a pigment a foam, a cellular or solid polyethylene foam, a solid ethylene vinyl acetate (EVA) foam, a foam comprising air bubbles to provide cellular or tissue texture, a reduced polynomial hyperelastic material, a urethane polymer, a silicone fluid, a deadening agent to soften a silicone component, a platinum cured silicone additive, a silicone oil, an alcohol; a commercial synthetic skin product;
the synthetic skin is sufficiently pliable so as to form a seal around a laparoscopic instrument passing therethrough such as a trocar;
the engagement between the housing and the cassette provides an airtight seal within the body cavity by means of a mechanical locking device comprising one or more of a clasp, a clip, a clamp, a rotating airlock,
the cassette comprises synthetic bony anatomical features as landmarks, the synthetic bony anatomical features to provide structural integrity for the cover and for anatomical placement and support of said organ models;
the pelvic model comprises an engagement means with a slot to provide releasable engagement with a pillar of the inner wall of the organ model support, the pelvic model comprising a cap to fasten a synthetic peritoneal tissue in place.

17. A surgical training apparatus according to claim 16 wherein:
the closed end of the housing defines an aperture for passage of a portion of an organ model to simulate an anatomical orifice; and
internal end of the drawer defines an aperture for passage of an organ model to simulate an anatomical orifice; and
the aperture defined by the closed end of the housing and the aperture defined by the internal end of the cassette arranged so as to form a continuous aperture for passage of an organ model to simulate an anatomical orifice; and
the surgical training apparatus housing and cassette together define an aperture shaped to receive an aperture-bearing organ model to simulate an anatomical orifice, the organ model further comprising simulated internal anatomy associated with the orifice optionally comprising an organ lumen, the orifice selected from an anal orifice, a vaginal orifice, a penile orifice; and
the aperture-bearing organ model, the housing and the cassette together form an airtight seal around the simulated orifice so as to enable insufflation of the body cavity while preserving the orifice and associated internal anatomical features which optionally comprising an organ lumen.

18. A surgical training apparatus according to claim 17 wherein:
the airtight seal around the simulated orifice comprises a flange on the aperture-bearing organ model wherein the flange is within the body cavity and on the inside of the aperture defined by the inner wall of the cassette and the airtight seal further comprising one or more annuli on an insert designed for air-tight fitting engagement with the organ model from outside the body cavity and outside the aperture;
the insert comprises an annulus for tight fitting engagement with an external organ model such as a synthetic skin model to simulate an external orifice which is optionally an anus, a vulval opening or a penis wherein the external orifice is continuous with the orifice of the aperture bearing organ model within the body cavity.

19. A surgical training apparatus according to claim 18 wherein:
the cassette comprises a length of approximately 450 to 600 mm, preferably 500 to 550 mm, more preferably 520 to 530 mm, more preferably about 526 mm, and a height of 200 to 400 mm, preferably 250 mm to 350 mm, more preferably 280 to 300 mm, more preferably about 291 mm;
the cassette engaging end of the housing comprises a first layer to adhere to a cover, a second layer to define an aperture for entry of the cassette and a third layer comprising a seal to engage in an airtight manner with an external end of the cassette.

20. A surgical training apparatus comprising a housing and a cassette:
the housing comprising a tray, side walls, and a closed end;
the closed end of the housing defining an aperture for passage of a portion of an organ model to simulate an anatomical orifice and the close end of the housing comprising a cassette-engaging end defining an aperture to receive the cassette;
the housing shaped externally to mimic a life sized torso and substantially covered on an operable surface by a cover which comprises one or more synthetic layers to simulate a body wall, the synthetic layers comprising synthetic skin and optionally one or more of muscle, connective tissue and fat with each layer adhered to another layer;
the cassette for holding one or more organ models in anatomical relationships with one another and with the external surface of the housing;
the cassette having a length of approximately 520 to 530 mm, preferably about 526 mm, and a height of 280 to 300 mm, preferably about 291 mm;
the cassette comprising a drawer being slidably engageable with the housing so as to be substantially surrounded by it and thereby define a body cavity with it;
the cover comprising one more of a thermoplastic elastomer, a silicone, a room temperature vulcanizing silicone, a platinum cured room temperature vulcanization silicone; a saturated fatty acid; a pigment, a foam, a cellular or solid polyethylene foam, a solid ethylene vinyl acetate (EVA) foam, a foam comprising air bubbles to provide cellular or tissue texture, a reduced polynomial hyperelastic material, a urethane polymer, a silicone fluid, a deadening agent to soften a silicone component, a platinum cured silicone additive, a silicone oil, an alcohol; a commercial synthetic skin product;
the synthetic skin sufficiently pliable so as to form a seal around a laparoscopic instrument passing therethrough; and being heat repairable, sufficiently resilient to enable suturing and sufficiently distensible so as to enable life-like expansion when pressure is applied from within the body cavity through insufflation while maintaining said seal;
the cassette engaging end of the housing comprising a first layer to adhere to a cover, a second layer to define an aperture for entry of the cassette and a third layer comprising a seal to engage in an airtight manner with an external end of the cassette;
the cassette comprising a drawer with an internal end, a support to hold an organ model, and an external end, the external end comprising a handle and the internal end defining an aperture for passage of an organ model to simulate an anatomical orifice;
the aperture defined by the closed end of the housing and the aperture defined by the internal end of the cassette arranged so as to form a continuous aperture for passage of an organ model to simulate an anatomical orifice;
the engagement between the housing and the cassette providing an airtight seal within the body cavity by means of a mechanical locking device the engagement between the housing and the cassette further comprising a seal on the housing and/or a seal on the cassette, the seal(s) comprising a silicon gasket and housed in a channel around the perimeter of the respective engaging parts of the housing and cassette;
the cassette comprising synthetic bony anatomical features as landmarks, the synthetic bony anatomical features to provide structural integrity for the cover and for anatomical placement and support of said organ models;
said synthetic bony anatomical features comprising a pelvic model, a rib model and a vertebral model, the pelvic model comprising an engagement means with a slot to provide releasable engagement with a pillar of the inner wall of the organ model support, the pelvic model comprising a cap to fasten a synthetic peritoneal tissue in place;
the door of the cassette comprising an airtight sealed port for passage of an electrical cable to provide current access for cautery and an airtight sealed port for passage of one or more tubes to provide simulated blood flow access;
the surgical training apparatus housing and cassette together defining an aperture shaped to receive an aperture-bearing organ model to simulate an anatomical orifice, the organ model further comprising simulated internal anatomy associated with the orifice comprising an organ lumen, the orifice selected from an anal orifice, a vaginal orifice, a penile orifice;
the aperture-bearing organ model, the housing and the cassette together forming an airtight seal around the simulated orifice so as to enable insufflation of the body cavity while preserving the orifice and associated internal anatomical features;
the airtight seal around the simulated orifice comprising a flange on the aperture-bearing organ model wherein the flange is within the body cavity and on the inside of the aperture defined by the inner wall of the cassette and the airtight seal further comprising one or more annuli on an insert designed for air-tight fitting engagement with the organ model from outside the body cavity and outside the aperture;
the insert comprising an annulus for tight fitting engagement with a cover comprising a synthetic skin model to simulate an external orifice selected from an anus, a vulval opening or a penis wherein the external orifice is continuous with the orifice of the aperture bearing organ model within the body cavity;
the body cavity comprising a hydrogel synthetic pelvic fat pad placed on the pelvic model and adhered to a diathermy pad, the pelvic fat pad to increase anatomical realism and provide a pathway for electrical current to connect with hydrogel tissue during electrocautery;
the body cavity comprising one or more further organ models selected from: a thoracic organ, a lung, a heart, a thymus, an abdominal organ, a stomach, small intestines, large intestines, a colon, a gall bladder, a rectum, a liver, a pancreas, a spleen, a kidney, an adrenal gland, a bladder, a female reproductive tract, a male reproductive tract, a lymph node, a peritoneal tissue, omentum, mesentery.

21. A surgical training apparatus for training a laparascopic surgical procedure involving a body cavity comprising a plurality of anatomical landmarks for use during the procedure wherein the anatomical landmarks comprise a synthetic skin overlying an anatomical structure.

22.-24. (canceled)

25. A surgical training apparatus according to claim 21 wherein the synthetic skin comprises a skin surface feature which is optionally one or more of a nipple, a fold, hair, a navel, a breast, a vagina, a penis.

26. A surgical training apparatus according to claim 21 wherein the synthetic skin comprises a plurality of additional layers to simulate one or more of muscle, fat and mesentery.
